(19) United States
(12) Patent Application Publication
(10) Pub. No.: US 2015/0242847 A1
(43) Pub. Date: Aug. 27, 2015

(54) METHOD AND SYSTEM FOR CONVERTING ASYNCHRONOUS TO SYNCHRONOUS TRANSACTIONS

(71) Applicant: MasterCard International Incorporated, Purchase, NY (US)

(72) Inventors: Christopher J. ERDELYI, Ballwin, MO (US); Gerard Joseph O'DONNELL, St. Peters, MO (US); Jensen James E. PASTRANA, O'Fallon, MO (US)

(73) Assignee: MasterCard International Incorporated, Purchase, NY (US)

(21) Appl. No.: 14/187,700

(22) Filed: Feb. 24, 2014

(51) Int. Cl. G06Q 20/38; G06Q 30/02

(52) U.S. Cl. CPC G06Q 20/38; G06Q 30/0233; G06Q 20/387

(57) ABSTRACT

A method for compiling asynchronous transactions includes: receiving, by a receiving device, a first asynchronous message, wherein the first asynchronous message includes at least transaction data and a destination; receiving, during a predetermined period of time, one or more additional asynchronous messages, wherein each of the one or more additional asynchronous messages includes at least transaction data; identifying, by a processing device, a resolved set of data based on at least the transaction data included in the first asynchronous message and the transaction data included in each of the one or more additional asynchronous messages; generating, by the processing device, a compiled message, wherein the compiled message includes at least the identified resolved set of data; and transmitting, by a transmitting device, the generated compiled message to the destination.

### FIELD

The present disclosure relates to the compiling of asynchronous transactions for processing, specifically the collection of asynchronous messages that are compiled into a single message with a resolved set of data for processing as a synchronous message.

### BACKGROUND

Communication between two different entities, such as in payment systems, may take on many different forms. In some cases, messages that are communicated may be either synchronous or asynchronous. Synchronous messages may require a response to be provided once received, while asynchronous messages may be received without a response being necessary. For example, in payment systems, an authorization request may be a synchronous message requiring an authorization response, while an instruction to deduct money or points from an account may be an asynchronous message.

Large networks, such as payment networks, may often times receive a vast number of synchronous and asynchronous messages every day. As the receipt of these messages may often require some type of action to be performed (e.g., instructions executed, responses generated and transmitted, etc.), the handling of a large volume of messages may require significant resources and processing power to ensure that each message, both synchronous and asynchronous are addressed.

In some instances, a system may receive several asynchronous messages related to a single transaction or account, which may require significant processing to address these messages. In cases where the messages may include competing or conflicting instructions, the receiving system may end up performing a number of unnecessary functions, which may come at a significant expense in resources, especially when compounded in instances where a system handles a large amount of traffic. Thus, the present inventors believe there is a need for a technical solution to compile asynchronous message into a single message in an effort to conserve resources and network traffic.

### SUMMARY

The present disclosure provides a description of systems and methods for compiling asynchronous transactions.

A method for compiling asynchronous transactions includes: receiving, by a receiving device, a first asynchronous message, wherein the first asynchronous message includes at least transaction data and a destination; receiving, during a predetermined period of time, one or more additional asynchronous messages, wherein each of the one or more additional asynchronous messages includes at least transaction data; identifying, by a processing device, a resolved set of data based on at least the transaction data included in the first asynchronous message and the transaction data included in each of the one or more additional asynchronous messages; generating, by the processing device, a compiled message, wherein the compiled message includes at least the identified resolved set of data; and transmitting, by a transmitting device, the generated compiled message to the destination.

A system for compiling asynchronous transactions includes a receiving device, a processing device, and a transmitting device. The receiving device is configured to: receive a first asynchronous message, wherein the first asynchronous message includes at least transaction data and a destination; and receive, during a predetermined period of time, one or more additional asynchronous messages, wherein each of the one or more additional asynchronous messages includes at least transaction data. The processing device is configured to: identify a resolved set of data based on at least the transaction data included in the first asynchronous message and the transaction data included in each of the one or more additional asynchronous messages; and generate a compiled message, wherein the compiled message includes at least the identified resolved set of data. The transmitting device is configured to transmit the generated compiled message to the destination.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for compiling asynchronous transactions in accordance with exemplary embodiments.

FIG. 2 is a block diagram illustrating the processing server of FIG. 1 for the compiling of asynchronous transactions into a compiled message in accordance with exemplary embodiments.

FIGS. 3A and 3B are a flow diagram illustrating a process for the compiling of asynchronous messages into a single message using the system of FIG. 1 in accordance with exemplary embodiments.

FIG. 4 is a flow diagram illustrating a process for the compiling of asynchronous transactions using the processing server of FIG. 2 in accordance with exemplary embodiments.

FIG. 5 is a diagram illustrating the compiling of asynchronous messages into a single compiled message in accordance with exemplary embodiments.

FIG. 6 is a flow chart illustrating an exemplary method for compiling asynchronous transactions in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

### System for Compiling Asynchronous Transactions

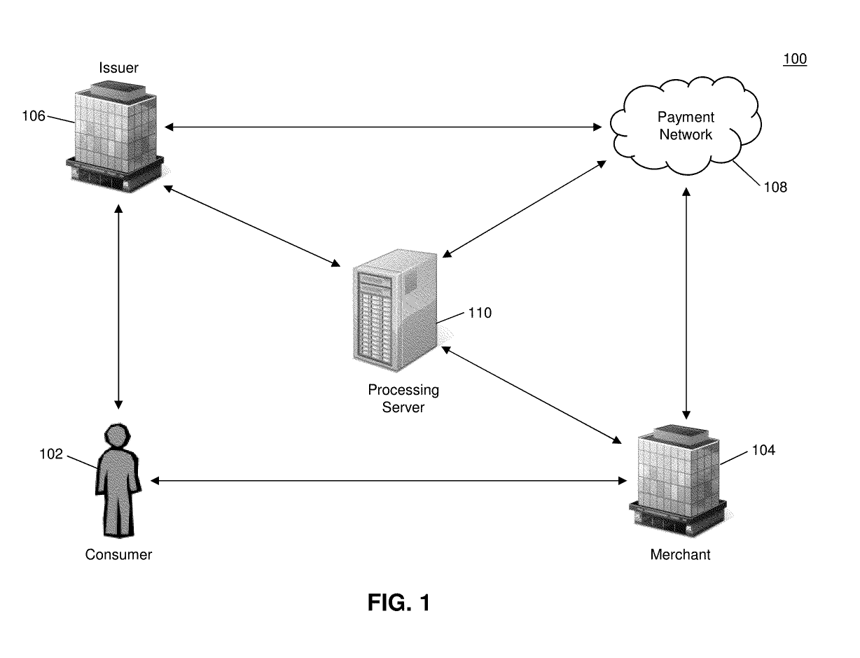

FIG. 1 illustrates a system 100 for the compiling of asynchronous transactions into a single, combined transaction.

The system 100 may include a consumer 102. The consumer 102 may engage in a transaction with a merchant 104, such as a payment transaction for the purchase of goods or services. In instances where the transaction may be a payment transaction, the consumer 102 may present a payment card or other suitable form of payment to fund the payment transaction involving the merchant 104. The payment card or other suitable payment method presented by the consumer 102 may be associated with a payment account that is associated with the consumer 102. The payment account may be held by an issuer 106, such as an issuing bank.

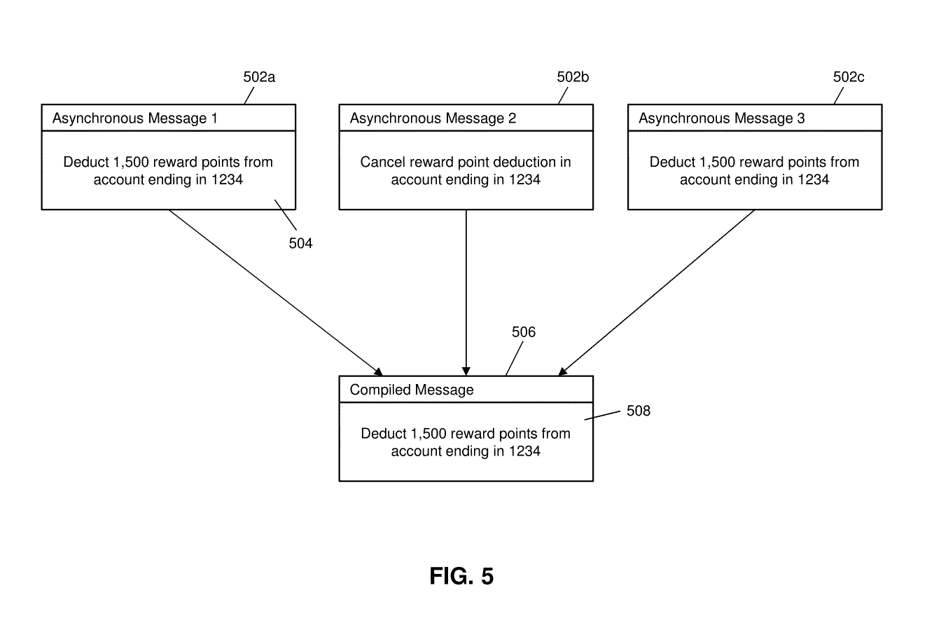

The payment transaction involving the consumer 102 and the merchant 104 may be processed by a payment network 108 using methods and systems that will be apparent to persons having skill in the relevant art. As part of the processing of the transaction, the payment network 108 may generate a plurality of asynchronous messages to be delivered to the issuer 106. For instance, in the example illustrated in FIG. 5 and discussed in more detail below, the asynchronous messages may include instructions for managing reward points associated with a payment account used by the consumer 102 to fund the payment transaction.

The asynchronous messages generated by the payment network 108 may be transmitted to a processing server 110. The processing server 110, discussed in more detail below, may be configured to compile the received asynchronous messages into a single, combined message. As discussed in more detail below, the processing server 110 may wait a predetermined period of time for receipt of related asynchronous messages. Once the predetermined period of time has ended, then the processing server 110 may analyze the asynchronous messages and identify a resolved set of data based on data included in the messages. The processing server 110 may then generate a single message including the resolved set of data, and forward the single message to the issuer 106.

Such a system may provide for a more efficient and streamlined method for processing asynchronous messages. The use of the processing server 110 to compile two or more asynchronous messages into a single message may result in a significantly less expenditure of resources by the issuer 106 by requiring less processing power and less bandwidth, as well as an increase in processing speed due to a decrease in overall volume of received asynchronous messages. The addition of other features, such as a queue for the transmitting of compiled messages to the issuer 106, the processing server 110 may be able to improve the processing of messages by the issuer 106 even more. It should be noted that, although the examples illustrated and discussed herein include the asynchronous messages as being related to a payment transaction, it will be apparent to persons having skill in the relevant art that the present systems and methods may be applicable to any suitable type of transaction.

### Processing Server

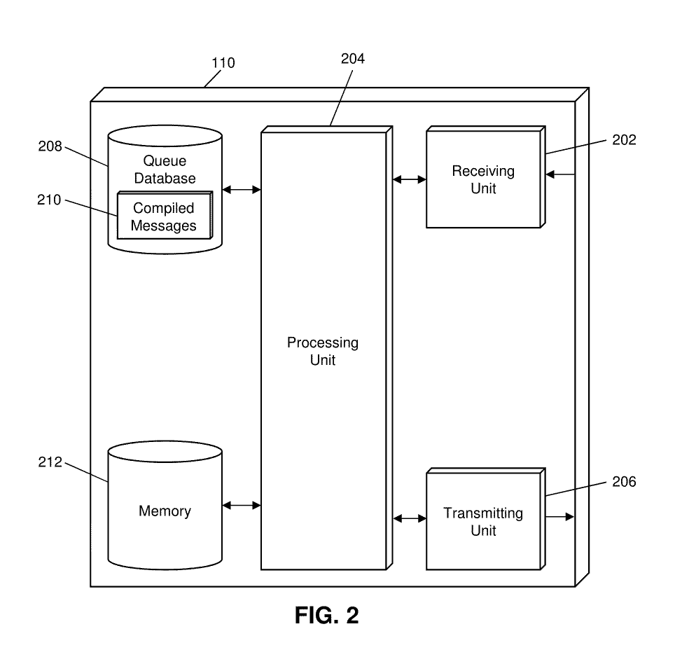

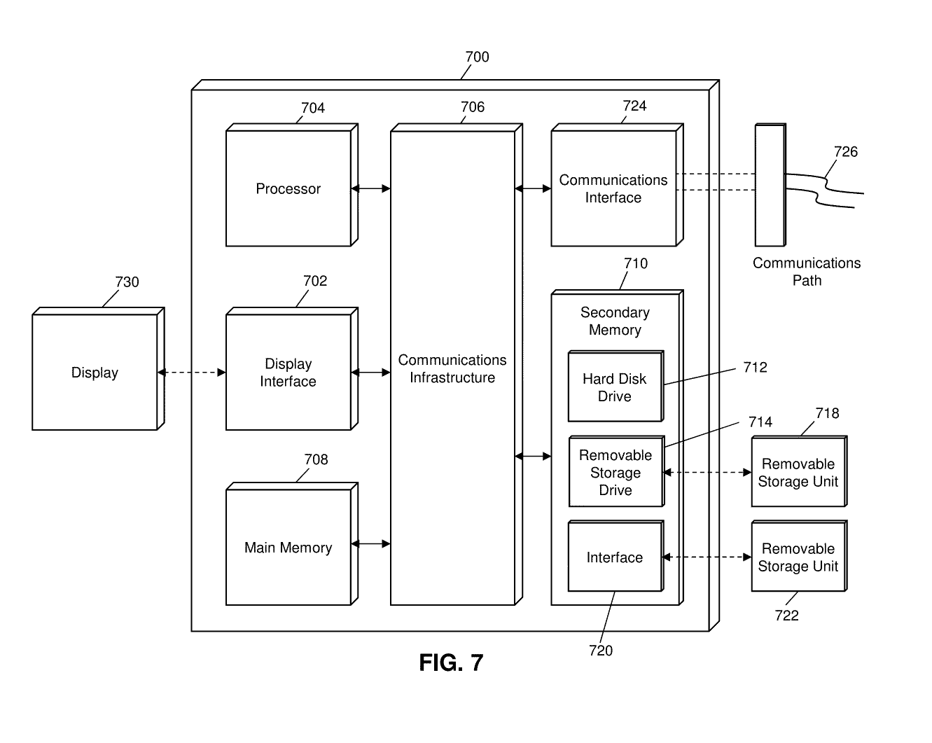

FIG. 2 illustrates an embodiment of the processing server 110 of the system 100. It will be apparent to persons having skill in the relevant art that the embodiment of the processing server 110 illustrated in FIG. 2 is provided as illustration only and may not be exhaustive to all possible configurations of processing server 110 suitable for performing the functions as discussed herein. For example, the computer system 700 illustrated in FIG. 7 and discussed in more detail below may be a suitable configuration of the processing server 110.

The processing server 110 may include a receiving unit 202. The receiving unit 202 may be configured to receive data over one or more networks via one or more network protocols. The receiving unit 202 may receive two or more asynchronous messages from the payment network 108. Each asynchronous message may include at least transaction data and a specified destination (e.g., the issuer 106). In some embodiments, each asynchronous message may also include a common reference code, such as to indicate that each asynchronous message is related to a single overall transaction.

The processing server 110 may also include a processing unit 204. The processing unit 204 may identify each of the received asynchronous messages for compiling into a single, combined message. The processing server 110 may identify a time at which a first asynchronous message is received and then may wait a predetermined period of time. The predetermined period of time may be stored in a memory 212 of the processing server 110 and may be based on one or more factors, such as the payment network 108, the issuer 106, the merchant 104, or the transaction data included in the first, or any subsequently received, asynchronous message.

Once the predetermined period of time is expired, the processing unit 204 may identify a resolved set of data based on the transaction data included in the first asynchronous message and each asynchronous message subsequently received by the receiving unit 202 during the predetermined period of time. In instances where the transaction data may include a set of instructions, identifying a resolved set of data may include generating a combined set of instructions based on the instructions included in each of the received asynchronous messages. The processing unit 204 may then generate a compiled message that includes the resolved set of data and the destination.

The processing server 110 may also include a transmitting unit 206. The transmitting unit 206 may be configured to transmit data over one or more networks via one or more network protocols. The transmitting unit 206 may transmit the generated compiled message to the destination (e.g., the issuer 106).

In some embodiments, the processing server 110 may also include a queue database 208. In such an embodiment, the processing unit 204 may store generated compiled messages in the queue database 208 as compiled messages 210. The transmitting unit 206 may then transmit compiled messages 210 to their respective destinations based on an order stipulated in the queue database 208. The use of a queue to transmit compiled messages 210 may improve the processing efficiency of the issuer 106 and/or the processing server 110 by prioritizing messages. The ordering of compiled messages 210 in the queue may be based on the respective resolved sets of data, the payment network 108, the issuer 106, or other suitable considerations as will be apparent to persons having skill in the relevant art.

### Process for Compiling Asynchronous Messages

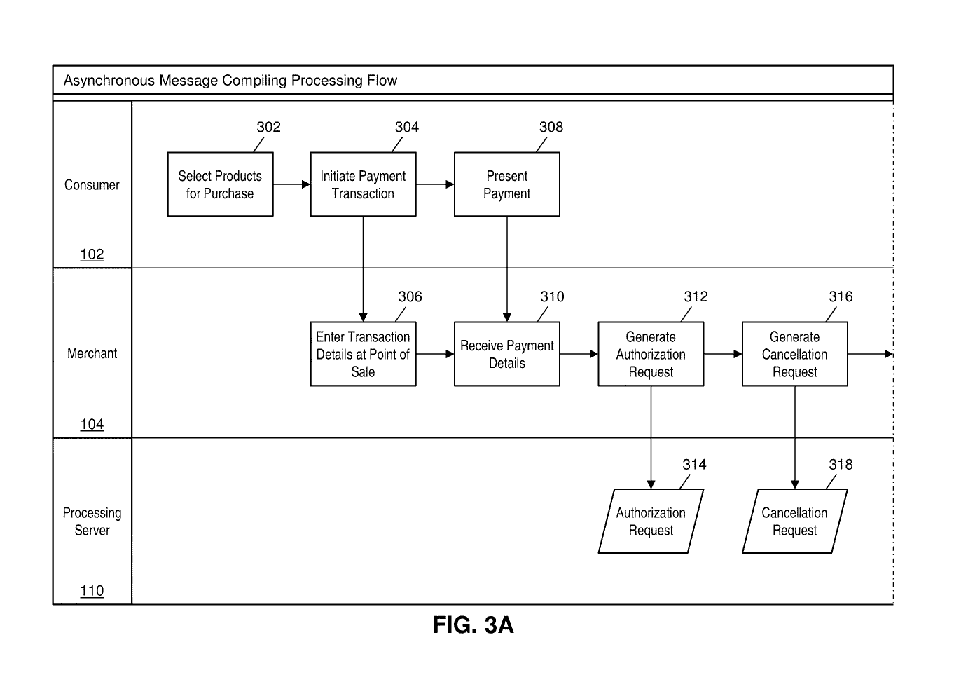

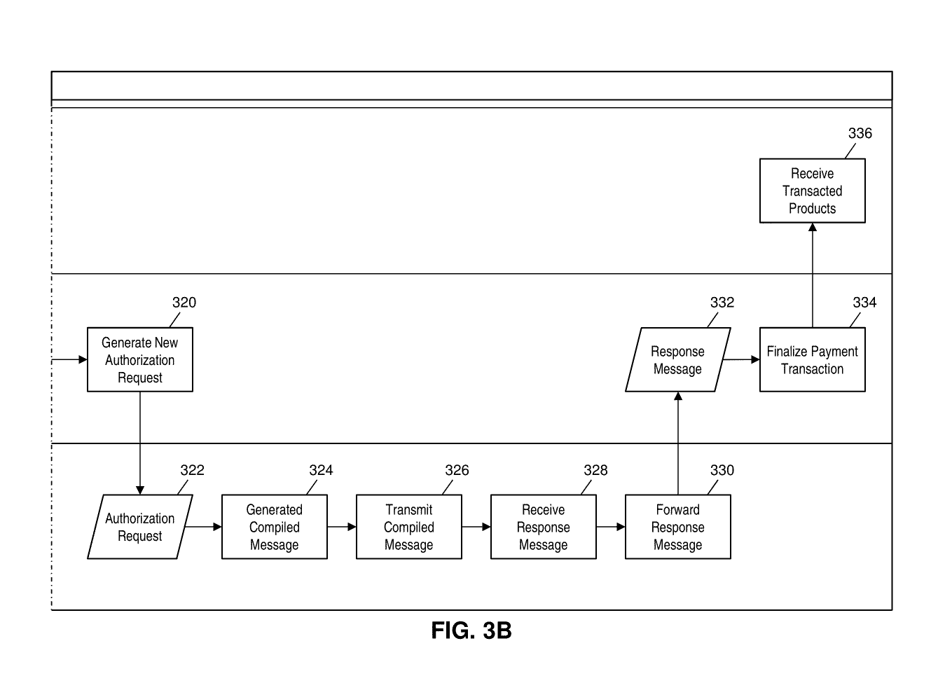

FIGS. 3A and 3B illustrate a process for the compiling of asynchronous messages into a compiled message for processing by the issuer 106.

In step 302, the consumer 102 may select products for purchase at the merchant 104. It will be apparent to persons having skill in the relevant art that the consumer 102 may physically select products, such as at a physical storefront of the merchant 104, or may do so virtually or remotely, such as via the Internet (e.g., at a website of the merchant 104). In step 304, the consumer 102 may initiate a payment transaction with the merchant 104.

In step 306, the merchant 104 may enter transaction details for the payment transaction at a point of sale. In step 308, the consumer 102 may present payment to the merchant 104 for funding the payment transaction. The payment method may be any suitable type of payment and may be associated with the issuer 106, such as a payment card issued to the consumer 102 by the issuer 106. In step 310, the merchant 104 may receive the payment details for the presented payment, such as by reading payment details encoded in a presented payment card.

In step 312, the merchant 104 (e.g., or an acquirer associated with the merchant 104) may generate an authorization request for the payment transaction, where the authorization request is an asynchronous message. The authorization request may be transmitted to the processing server 110, and, at step 314, received by the receiving unit 202 of the processing server 110. The processing server 110 may then wait the predetermined period of time before processing the authorization request.

During the predetermined period of time, the merchant 104 may, in step 316, generate submit a cancellation request, which may be an asynchronous message including instructions to cancel the previously submitted authorization request. In step 318, the receiving unit 202 of the processing server 110 may receive the cancellation request from the merchant 104. In step 320, the merchant 104 may generate a new authorization request, which may be another asynchronous message that is a correction from the originally generated and submitted authorization request. In step 322, the processing server 110 may receive the new authorization request, still within the predetermined period of time.

Once the predetermined period of time has expired, then, in step 324, the processing unit 204 of the processing server 110 may generate a compiled message, as discussed in more detail below. In step 326, the transmitting unit 206 of the processing server 108 may transmit the compiled message to the destination indicated in the originally received asynchronous message, such as the issuer 106. In step 328, a response to the compiled message may be received by the receiving unit 202, such as a response indicating approval of the payment transaction. In step 330, the transmitting unit 206 may forward the response message to the merchant 104, which may receive the message in step 332.

In step 334, the merchant 104 may finalize the transaction with the consumer 102, such as by furnishing the transacted for products to the consumer 102. The consumer 102 may receive the transacted for products, in step 336. It will be apparent to persons having skill in the relevant art that steps 328 to 336 may be optional, such as in instances where the issuer 106 may not provide any response to the compiled message.

### Compilation of Asynchronous Messages

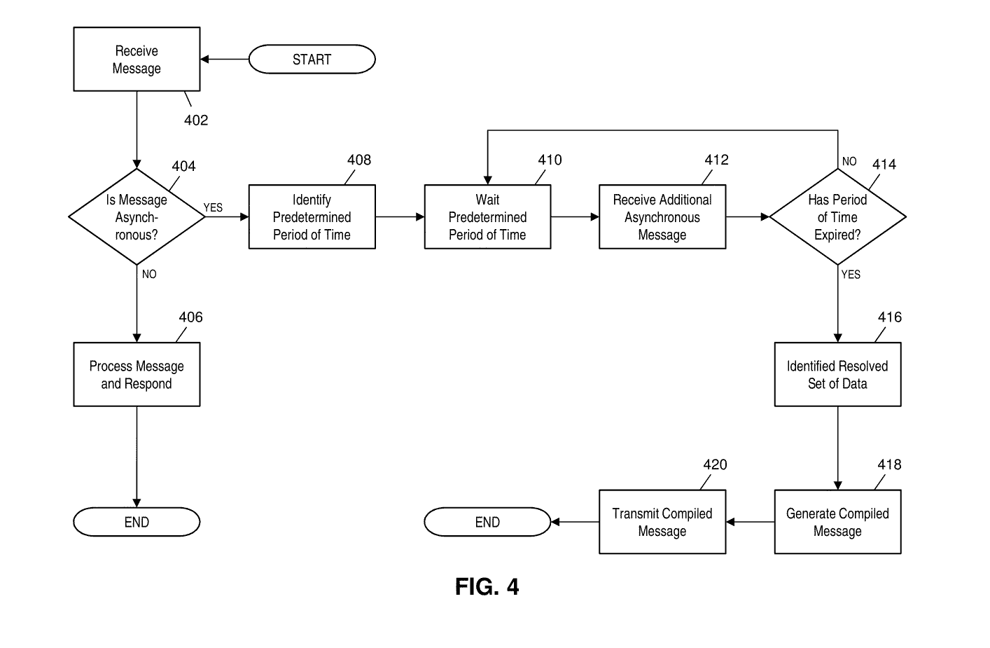

FIG. 4 illustrates a process 400 for the compilation of asynchronous messages into a single, compiled message by the processing server 110.

In step 402, the receiving unit 202 of the processing server 110 may receive a message. The message may include at least transaction data and a destination, such as the issuer 106. In step 404, the processing unit 204 may analyze the message and identify if the message is asynchronous. If the message is not asynchronous, then, in step 406, the processing unit 204 may process the message as a synchronous message, such as by forwarding the message (e.g., via the transmitting unit 206) to the destination, receiving a response, and forwarding the response to the originally received message.

If the message is asynchronous, then, in step 408, the processing unit 204 may identify a predetermined period of time. The predetermined period of time may be based on the transaction data included in the received asynchronous message, may be stored in the memory 212 of the processing server 110, or may be based on other criteria as will be apparent to persons having skill in the relevant art. In step 410, the processing server 110 may wait during the predetermined period of time before acting on the received asynchronous message.

In step 412, an additional asynchronous message may be received by the receiving unit 202. The additional asynchronous message may include new transaction data and may include the same destination as the originally received asynchronous message. In some embodiments, the additional asynchronous message may include a reference number also included in the originally received asynchronous message to identify its association with the original message. In step 414, the processing unit 204 may identify if the predetermined period of time has expired. If it has not expired, then the processing server 110 may return to step 410 and continue to wait and receive any additional asynchronous messages.

Once the predetermined period of time has expired, then, in step 416, the processing unit 204 may identify a resolved set of data based on at least the transaction data included in each of the received asynchronous messages, such as described in more detail below with respect to FIG. 5. In step 418, the processing unit 204 may generate a compiled message that includes at least the identified resolved set of data. In step 420, the transmitting unit 206 may transmit the compiled message to the destination for processing.

FIG. 5 illustrates the identification of a resolved set of data based on transaction data included in received asynchronous messages. It will be apparent to persons having skill in the relevant art that, although the example illustrated in FIG. 5 shows the transaction data including sets of instructions, any suitable type of data included in the transaction data may be compiled using the methods and systems discussed herein.

In the example illustrated in FIG. 5, the receiving unit 202 of the processing server 110 may receive three different asynchronous messages 502 during the predetermined period of time, illustrated as asynchronous messages 502a, 502b, and 502c. Each asynchronous message 502 may include transaction data 504, which may include a set of instructions. For example, asynchronous message 502a includes an instruction to deduct 1,500 reward points from an account (e.g., associated with the consumer 102) ending in 1234, such as for a pay-with-rewards transaction.

The receiving unit 202 may also receive asynchronous message 502b, which may include an instruction to cancel the deduction indicated in the previously received asynchronous message 502a. Asynchronous message 502c may include a reinstatement of the instruction to deduct the 1,500 reward points from the account ending in 1234. The processing unit 204 may analyze the instructions included in the transaction data 504 for each asynchronous message 502 and identify a resolved set of data 508 based on the instructions.

In the example illustrated in FIG. 5, the resolved set of data 508 may be an instruction to deduct 1,500 points once from the account ending in 1234. The processing unit 204 may then generate a compiled message 506 including the resolved set of data 508, which may then be transmitted, by the transmitting unit 206, to the issuer 106 for processing. By compiling the transaction data 504 into a resolve set of data 508, the issuer 106 may receive a single instruction to follow, whereas the issuer 106 would have received several instructions if each asynchronous message 502 were received.

### Exemplary Method for Compiling Asynchronous Transactions

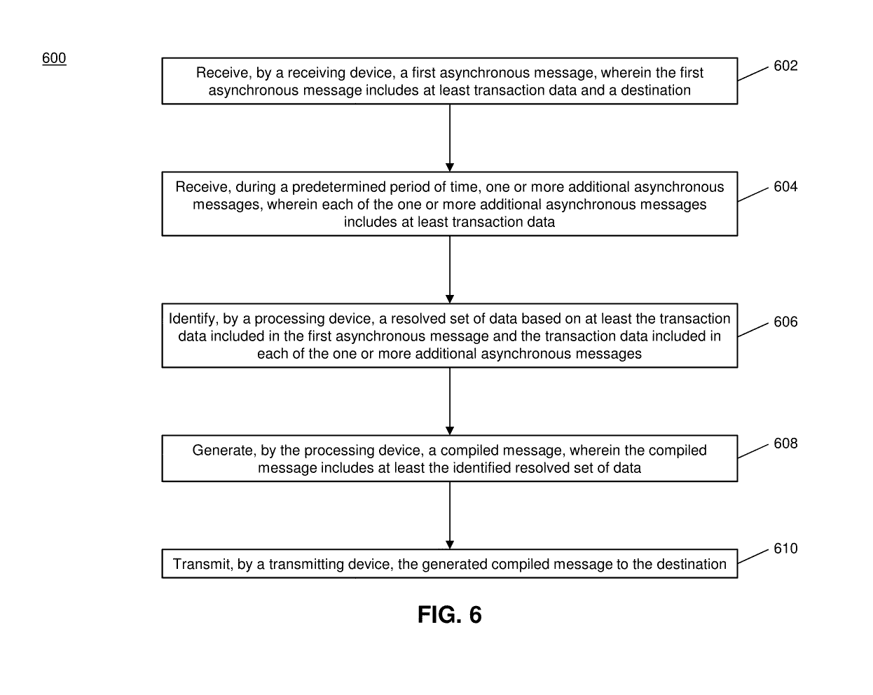

FIG. 6 illustrates a method 600 for the compiling of asynchronous transactions into a single compiled message.

In step 602, a first asynchronous message may be received by a receiving device (e.g., the receiving unit 202), wherein the first asynchronous message includes at least transaction data and a destination. In some embodiments, the transaction data may include at least one of: transaction time and/or date, transaction amount, merchant data, product data, consumer data, payment method, account identifier, reward identifier, and coupon data. In one embodiment, the first asynchronous message may correspond to a payment transaction for the purchase of goods or services. In a further embodiment, the payment transaction may be a pay-with-rewards transaction.

In step 604, one or more additional asynchronous messages may be received during a predetermined period of time, wherein each of the one or more additional asynchronous messages includes at least transaction data. In one embodiment, the first asynchronous message and each of the one or more additional asynchronous messages may include a common reference code. In some embodiments, the first asynchronous message may include a message time and/or date, and the predetermined period of time may begin at the message time and/or date. In other embodiments, the predetermined period of time may be based on the transaction data included in the first asynchronous message.

In step 606, a resolved set of data may be identified, by a processing device (e.g., the processing unit 204), based on at least the transaction data included in the first asynchronous message and the transaction data included in each of the one or more additional asynchronous messages. In some embodiments, the transaction data may include a set of instructions, and the resolved set of data may include a resolved set of instructions based on the set of instructions included in the transaction data of the first asynchronous message and each of the one or more additional asynchronous messages.

In step 608, a compiled message may be generated by the processing device 204, wherein the compiled message includes at least the identified resolved set of data. In step 610, the generated compiled message may be transmitted, by a transmitting device (e.g., the transmitting unit 206), to the destination. In one embodiment, the method 600 may further include storing, in a database (e.g., the queue database 208), the generated compiled message. In a further embodiment, transmitting the generated compiled message may be based on a queue order of the generated compiled message stored in the database 208.

### Computer System Architecture

FIG. 7 illustrates a computer system 700 in which embodiments of the present disclosure, or portions thereof, may be implemented as computer-readable code. For example, the processing server 110 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3A, 3B, 4, and 6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3A, 3B, 4, and 6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

Techniques consistent with the present disclosure provide, among other features, systems and methods for compiling asynchronous transactions. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for compiling asynchronous transactions, comprising:
receiving, by a receiving device, a first asynchronous message, wherein the first asynchronous message includes at least transaction data and a destination;
receiving, during a predetermined period of time, one or more additional asynchronous messages, wherein each of the one or more additional asynchronous messages includes at least transaction data;
identifying, by a processing device, a resolved set of data based on at least the transaction data included in the first asynchronous message and the transaction data included in each of the one or more additional asynchronous messages;
generating, by the processing device, a compiled message, wherein the compiled message includes at least the identified resolved set of data; and
transmitting, by a transmitting device, the generated compiled message to the destination.

2. The method of claim 1, wherein the first asynchronous message and each of the one or more additional asynchronous messages includes a common reference code.

3. The method of claim 1, wherein the transaction data includes a set of instructions, and wherein the resolved set of data includes a resolved set of instructions based on the set of instructions included in the transaction data of the first asynchronous message and each of the one or more additional asynchronous messages.

4. The method of claim 1, wherein the first asynchronous message includes a message time and/or date, and wherein the predetermined period of time begins at the message time and/or date.

5. The method of claim 1, wherein the predetermined period of time is based on the transaction data included in the first asynchronous message.

6. The method of claim 1, wherein the transaction data includes at least one of: transaction time and/or date, transaction amount, merchant data, product data, consumer data, payment method, account identifier, reward identifier, and coupon data.

7. The method of claim 1, further comprising:
storing, in a database, the generated compiled message.

8. The method of claim 7, wherein transmitting the generated compiled message is based on a queue order of the generated compiled message stored in the database.

9. The method of claim 1, wherein the first asynchronous message corresponds to a payment transaction for the purchase of goods or services.

10. The method of claim 9, wherein the payment transaction is a pay-with-rewards payment transaction.

11. A system for compiling asynchronous transactions, comprising:
a receiving device configured to
receive a first asynchronous message, wherein the first asynchronous message includes at least transaction data and a destination, and
receive, during a predetermined period of time, one or more additional asynchronous messages, wherein each of the one or more additional asynchronous messages includes at least transaction data;
a processing device configured to
identify a resolved set of data based on at least the transaction data included in the first asynchronous message and the transaction data included in each of the one or more additional asynchronous messages, and
generate a compiled message, wherein the compiled message includes at least the identified resolved set of data; and
a transmitting device configured to transmit the generated compiled message to the destination.

12. The system of claim 11, wherein the first asynchronous message and each of the one or more additional asynchronous messages includes a common reference code.

13. The system of claim 11, wherein the transaction data includes a set of instructions, and wherein the resolved set of data includes a resolved set of instructions based on the set of instructions included in the transaction data of the first asynchronous message and each of the one or more additional asynchronous messages.

14. The system of claim 11, wherein the first asynchronous message includes a message time and/or date, and wherein the predetermined period of time begins at the message time and/or date.

15. The system of claim 11, wherein the predetermined period of time is based on the transaction data included in the first asynchronous message.

16. The system of claim 11, wherein the transaction data includes at least one of: transaction time and/or date, transaction amount, merchant data, product data, consumer data, payment method, account identifier, reward identifier, and coupon data.

17. The system of claim 11, further comprising:
a database configured to store the generated compiled message.

18. The system of claim 17, wherein the transmitting device is configured to transmit the generated compiled message based on a queue order of the generated compiled message stored in the database.

19. The system of claim 11, wherein the first asynchronous message corresponds to a payment transaction for the purchase of goods or services.

20. The system of claim 19, wherein the payment transaction is a pay-with-rewards payment transaction.
